(19) United States
(12) Patent Application Publication
(10) Pub. No.: US 2025/0107650 A1
(43) Pub. Date: Apr. 3, 2025

(54) Equipment Hanging Device

(71) Applicant: Sportwaves Unlimited, Inc., Lafayette, CO (US)

(72) Inventors: Herbert E. Riehl, Erie, CO (US); Timothy C. Riehl, Longmont, CO (US)

(73) Assignee: Sportwaves Unlimited, Inc., Lafayette, CO (US)

(21) Appl. No.: 18/905,429

(22) Filed: Oct. 3, 2024

Related U.S. Application Data
(60) Provisional application No. 63/587,650, filed on Oct. 3, 2023.

(51) Int. Cl. A47G 29/08

(52) U.S. Cl. CPC A47G 29/08

(57) ABSTRACT

An equipment hanging device includes a equipment loop for holding a large item such as a bat, and hanging arms for attaching smaller items like mitts and helmets. The hanging device has a body from which hang the loop and two arms. Another hanging arm is attached at the bottom of the equipment loop. At the top of the body is a looped hanger strap to which a clip may be attached. The clip might be configured to hang from a chain link fence or the like. The front of the hanging device body has an area for inserting a front insert, and the back of the hanging device body has an area for a back insert. For example the back insert plate might be a transparent window to allow something like a picture or sticker to be placed behind the window. The front insert plate might be a badge showing a brand logo or the like. A retaining band may be used to hold the window and plates in place.

### BACKGROUND OF THE INVENTION

### Field of the Invention

The present invention relates to an equipment hanging device.

### Discussion of Related Art

Athletes have various items of equipment to keep track of. For example, a softball player may have a helmet, a bat, batting gloves, and a mitt. The softball player would like to keep all of these items together, organized, and easily accessible.

### SUMMARY OF THE INVENTION

An equipment hanging device or equipment hanger includes a equipment loop for holding a large item such as a bat, and hanging arms for attaching smaller items like mitts and helmets. The hanging device has a body with a front and back, from which hang the loop and arms. At the top of the body is a looped hanger strap to which a clip (e.g. a snap hook) may be attached. The clip might be configured to hang from a peg or a chain link fence or the like.

The front of the hanging device body has an area for inserting a front insert, and the back of the hanging device body has an area for a back insert. For example the back insert plate might be a transparent element acting as window to allow something like a badge with a player's name and team logo to be inserted behind the window. The front insert plate might be a badge showing a brand logo or the like. In some embodiments a retaining band may be used to hold the window and plates in place.

One example of a hanging device has three hanging arms. The equipment loop hangs directly from the bottom of the hanging device body and has a hanging arm attached to the bottom of the equipment loop. On either side of the equipment loop, a hanging arm is attached to the hanging device body. The equipment loop includes an adjusting collar used to tighten the equipment loop around a bat handle or the like.

The ends of the hanging arms are configured to attach hanging arm hooks, so that items such as helmets and gloves may be attached to the hanging arm hooks. For example, the hanging arms may form hook openings.

In some embodiments, the hanging device, including the hanging device body, the equipment loop, the hanging arms, and the looped hanger strap are all formed as a single piece, for example by injection molding. The retaining band and the adjusting collar may be formed as part of the same piece and then detached for use, or may be formed as separate pieces.

An equipment hanger has a body having a front side and a back side, and a top and a bottom, two hanging arms attached to and hanging from the bottom of the body, an equipment loop attached to and hanging from the bottom of the body, and a loop arm attached to and hanging from the equipment loop.

In some embodiments, the body, the hanging arms, the equipment loop and the loop arm are all formed integrally as a single piece, for example injection molded from thermoplastic polyurethane (TPU). In some embodiments, the hanging arms and the loop arm form hook openings to hold hooks. The hooks may form wider hook heads extending from narrower hook bodies so that when a hook body is threaded through a hook opening the hook head is stopped by the hook opening and holds the hook in place.

Some embodiments include an inset on the front of the body, the back of the body, or both for inserting plates. One plate might be a transparent window to hold a custom insert in place. The transparent window may be held in place at the bottom by being inserted into slots at the bottom of the inset. It may be held in place at the top by a retaining band. Inserts may also be glued on, or held in place by inserting the insert into tabs on the body.

As a feature, the equipment hanger has pinholes for inserting things like pins and awards. A collar may be used to tighten the equipment loop by sliding the collar down the equipment loop.

Some embodiments are formed of a flexible, stretchy material like TPU. This allows, for example, different sizes of bats to be placed within the equipment loop. For example, the material might stretch from around 5% to around 20% depending on the desired use. It also allows the equipment hanger to be rolled up and the arms to be moved to a desired configuration.

### BRIEF DESCRIPTION OF THE DRAWINGS

FIG. 1 is a front view of an equipment hanging device.

FIG. 2 is an exploded back isometric view of the equipment hanging device, also showing the front insert, the back transparent window, a rivet or threaded fastener for fastening the looped hanger strap and a clip to attach to the looped hanger strap.

FIG. 3 is a front isometric view of the equipment hanging device with the front insert, and the clip attached and secured by the rivet. It also shows an adjusting collar, hanging hooks and a retaining strap in place.

FIG. 4 is an isometric view of a hanging hook being inserted into the end of a hanging strap.

FIG. 5 is a side view of the hanging hook attached to a hanging strap.

FIG. 6 is a detailed front view of the equipment loop with its adjusting collar and two hanging arms all attached to the bottom of the equipment hanging device body.

FIG. 7 is a detailed isometric view of the adjusting collar.

FIG. 8 is a detailed isometric view of the retaining band.

### DETAILED DESCRIPTION OF THE INVENTION

TABLE 1

| Reference number | Element |
|---|---|
| 100 | Hanging device |
| 102 | Front inset area of body |
| 104 | Hanging arms |
| 106 | Large equipment loop |
| 108 | Equipment loop hanging arm |
| 110 | Hook openings to hold hooks |
| 112 | Body |
| 114 | Back inset area of body |
| 116 | Pinholes for pins or awards |
| 118 | Grooves for retaining band 802 |
| 120 | Front face tabs |
| 122 | Back face slots to hold window 206 |
| 124 | Looped hanger strap |
| 202 | Clip or snap hook |
| 204 | Rivet for hanger strap 124 |
| 206 | Transparent window back plate |
| 208 | Front plate |
| 302 | Adjusting collar for loop |
| 304 | Hanging hooks |
| 402 | Head of hook 304 |
| 406 | Neck of hook 304 |
| 408 | Hook ridges |
| 410 | Hook body |
| 602 | Loop 106 arms |
| 702 | Collar openings for loop arms 602 |
| 802 | Retaining band |

Table 1 provides a list of device elements and their associated reference numbers in the figures.

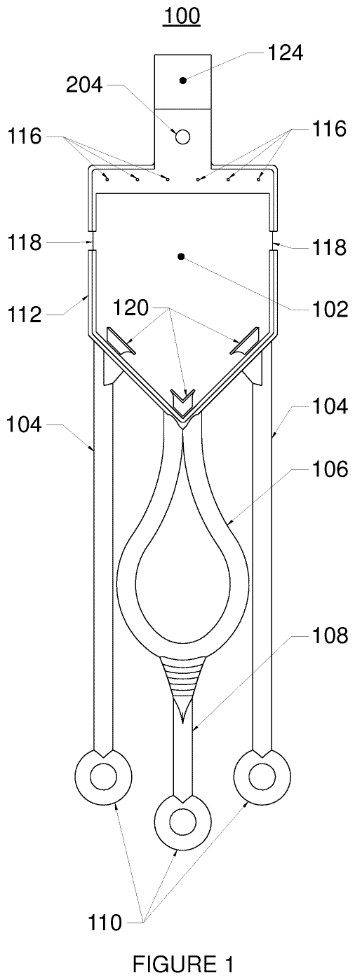

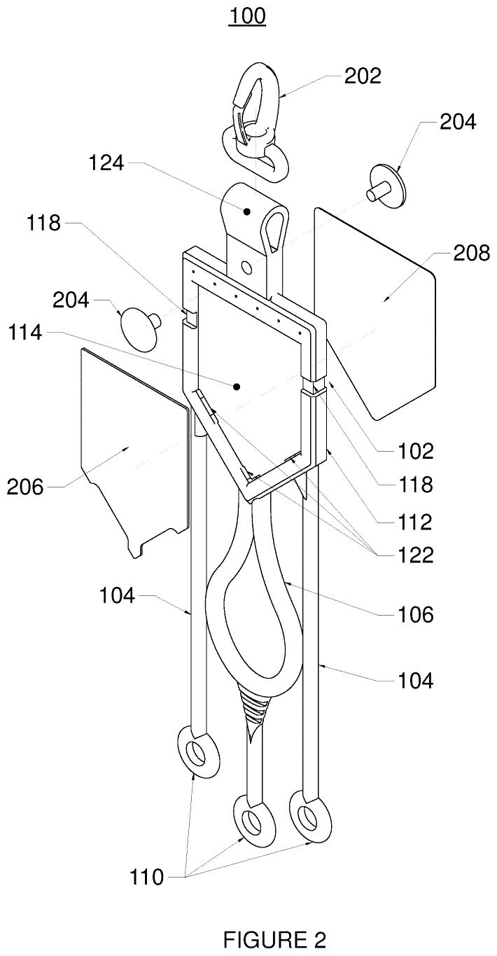

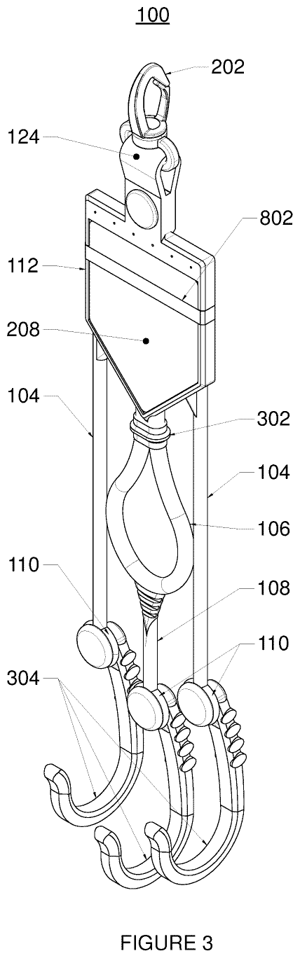

FIG. 1 is a front view of an equipment hanging device 100. It includes a body 112, with a front inset area 102 on its front side, two hanging arms 104 attached to the bottom of body 100, a large equipment loop 106 attached to the bottom of body 112 with an equipment loop hanging arm 108 attached to the bottom of equipment loop 106, and a looped hanger strap 124 attached to the top of body 112. For simplicity, several elements have been left off equipment hanging device 100 in FIG. 1. FIGS. 2 and 3 show equipment hanging device 100 assembled with hardware which improves the functionality of equipment hanging device 100, including clip 202 for hanging equipment hanging device 100 from a post, chain link fence, a peg etc., as well as hanging hooks 304 to attach equipment. Clip 202 may swivel. This is especially helpful if it is to be attached to a chain link fence. Equipment hanging device 100 may include multiple pinholes 116 for attaching pins and awards and the like, here along the top of equipment hanging device 100.

Equipment hanging device 100 may be made of a number of different materials. One type of material that works well is flexible, slightly stretchy plastic such as TPU. Equipment hanging device 100 is especially useful for organizing baseball or softball equipment and keeping it assembled. The end of a bat (not shown) may be inserted into equipment loop 106, and a stretchy material allows for a tighter fit around the handle to hold the bat in place. As shown in FIG. 3, a collar may be used to tighten equipment loop 106 around a bat handle as well.

It is convenient to manufacture equipment hanging device 100 to comprise a single integral piece. For example, it may be molded or 3D printed as a single piece. As an alternative, equipment hanging device may be cut and sewn.

Other features of equipment hanging device 100 include holes for inserting pins or awards, and features for attaching inserts on either side of the body, better shown in FIGS. 2 and 3.

FIG. 2 is an exploded back isometric view of equipment hanging device 100, also showing front insert plate 208, back transparent window 206, a rivet or screw 204 for fastening looped hanger strap 124 and a clip 202 to attach to the looped hanger strap. Plates and inserts may comprise dome tags or stickers. As an alternative, two window plates may be used, or two badge plates. Or just one of these or none may be used. The plates may be held in place by permanent affixing like glue, by slots, by tabs, by a retaining band, or various combinations.

Back window plate 206 may be inserted into back face slots 122 to place and retain back window 206 on the back side of body 112. Window 206 is transparent and may be formed of PET or the like. Front plate insert 208 may be inserted in tabs 120 within front inset area 102, shown in FIG. 1.

As shown in FIGS. 3 and 8, retaining band 802 may also be used to hold back window 206, as well as front plate 208, in place. Back window 206 allows inserts (not shown) to be inserted between back window 206 and back inset area 114 of body 112. For example, an owner might insert a player picture, team logo, etc.

FIG. 3 is a front isometric view of the equipment hanging device assembled with front insert plate 208, and clip 202. It also shows an adjusting collar 302, hanging hooks 304 and a retaining band 802 in place. Hooks 304 are useful in attaching equipment like batting gloves, mitts, helmets, etc.

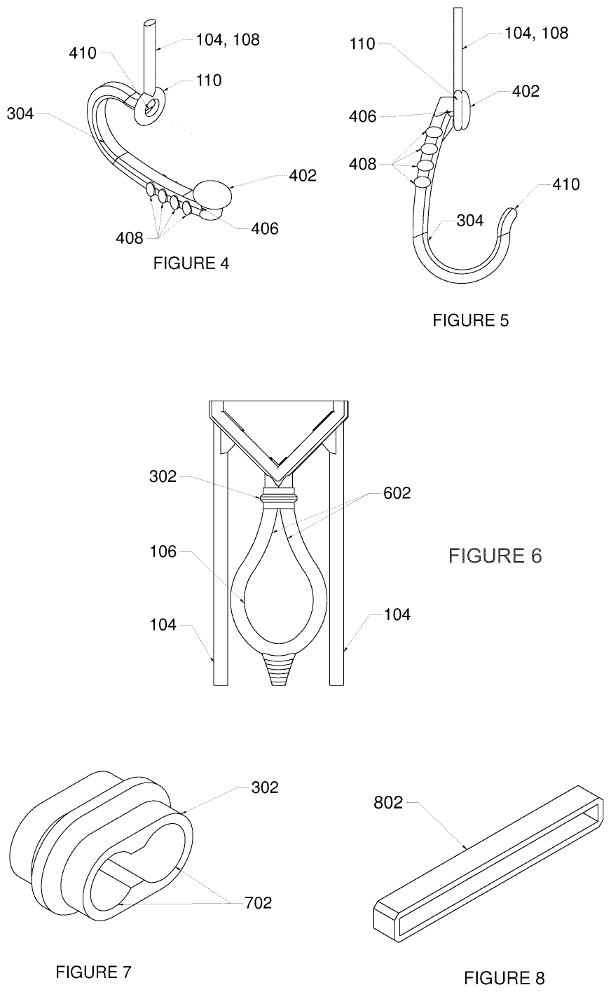

Hooks 304 may be attached as shown in FIGS. 4 and 5. Retaining band 802 holds front insert plate 208 and back transparent window plate 206 in place, and may also serve a decorative purpose. For example retaining band 802 may have a team name emblazoned on it.

Collar 302 is used to tighten equipment loop 106, for example around a bat handle. It is better shown in FIG. 7.

FIG. 4 is an isometric view of a hanging hook 304 being threaded through hook opening 110 of a hanging arm 104 or 108. FIG. 5 is a side view of hanging hook 304 attached to hook opening 110 of hanging arm 104 or 108. In this example, the hooks 304 form wider hook heads 402 extending from narrower hook bodies 410, and a hook body 410 is inserted end first through circular hook opening 110 and hook 304 continues sliding through hanging arm hook opening 110 until wider head 402 of hook 304 is seated adjacent to hook opening 110, holding hook 304 in place. Hook opening 110 may be formed of a stretchy material so that it tightens around neck 406 of hook 304. Hook 304 also may include hook ridges 408 for extra grip. Hanging hooks 304 are generally formed of a hard plastic. Metal hooks may also be used.

FIG. 6 is a detailed front view of equipment loop 106 with its adjusting collar 302 disposed around equipment loop 106. Equipment loop 106 is attached to the bottom of equipment hanging device body 112. In some examples, collar 302 is slid over equipment loop hanging arm 108 and equipment loop 106 to be located at the top of equipment loop 106. It is helpful for collar 302 to be formed of a stretchy material to allow it to slide over these elements and form a tight fit around arms 602.

One design for adjusting collar 302 is shown in FIG. 7. Adjusting collar 302 includes two collar openings 702 for loop arms 602. If adjusting collar 302 is to slide over equipment loop 106, the two collar openings form one larger opening as shown in FIG. 7.

FIG. 8 is a detailed isometric view of retaining band 802. Retaining band 802 is useful for holding front plate 208 and back transparent window plate 206 in place on body 112. It fits within grooves 118 on body 112, best shown in FIG. 2.

In some embodiments, hanging device 100, including hanging device body 112, equipment loop 106, hanging arms 104, and looped hanger strap 124 are all formed as a single piece, for example by injection molding. If desired, retaining band 802 and adjusting collar 302 may also be formed as part of the same piece and then detached for use.

Note that Terms such as “above”, “below”, “back”, “front”, “top”, “bottom”, etc. are used for convenience in describing the drawings. Those skilled in the art will appreciate that various configurations and placements of the device and its elements fall within the spirit of the device. For example, either side of the body may be the front or the back. The bottom of the body might be level with or above the top of the body if the equipment hanger is turned.

While the exemplary preferred embodiments of the present invention are described herein with particularity, those skilled in the art will appreciate various changes, additions, and applications other than those specifically mentioned, which are within the spirit of this invention.

1. An equipment hanger comprising:
a body having a front side and a back side, and a top and a bottom;
two hanging arms attached to and hanging from the bottom of the body;
an equipment loop attached to and hanging from the bottom of the body; and
a loop arm attached to and hanging from the equipment loop;
wherein the body, the hanging arms, the equipment loop and the loop arm are all formed integrally as a single piece.

2. The equipment hanger of claim 1 further comprising a back inset on the back side of the body for inserting a back plate.

3. The equipment hanger of claim 2 further comprising a front inset on the front side of the body for inserting a front plate.

4. The equipment hanger of claim 2 further comprising a retaining band 802 configured to hold the back plate in place in the back inset.

5. The equipment hanger of claim 1 further forming multiple pinholes on the body configured to allow attachment of pins.

6. The equipment hanger of claim 1 wherein the single piece is injection molded.

7. The equipment hanger of claim 1 wherein the single piece is formed of TPU.

8. The equipment hanger of claim 1 further comprising hooks and wherein the hanging arms and the loop arm further form hook openings for attaching the hooks.

9. The equipment hanger of claim 8 wherein the hooks form wider hook heads extending from narrower hook bodies and wherein the hook bodies are configured to thread through the hook openings and the hook heads hold the hooks in place within the hook openings in use.

10. The equipment hanger of claim 1 further comprising a collar disposed around the equipment loop and configured to tighten the equipment loop when the collar slides down the equipment loop.

11. An equipment hanger comprising:
a body having a front side and a back side, and a top and a bottom;
two hanging arms attached to and hanging from the bottom of the body;
an equipment loop attached to and hanging from the bottom of the body; and
a loop arm attached to and hanging from the equipment loop;
wherein the hanging arms and the loop arm form hook openings for attaching hooks.

12. The equipment hanger of claim 11 wherein the hooks form wider hook heads extending from narrower hook bodies and wherein the hook bodies are configured to thread through the hook openings and the hook heads hold the hooks in place within the hook openings in use.

13. An equipment hanger comprising:
a body having a front side and a back side, and a top and a bottom;
two hanging arms attached to and hanging from the bottom of the body;
an equipment loop attached to and hanging from the bottom of the body; and
wherein the body forms a back inset on the back side of the body configured for inserting a back plate.

14. The equipment hanger of claim 13 further comprising a transparent window configured to hold the back plate in place within the back inset.

15. The equipment hanger of claim 14 wherein the back inset forms slots configured for inserting the window.

16. The equipment hanger of claim 15, further comprising a retaining band configured to hold the back plate in place in the back inset.

17. The equipment hanger of claim 13 wherein the body further forms a front inset on the front side of the body configured for inserting a front plate.

18. The equipment hanger of claim 17 wherein the body further forms tabs configured for inserting the front plate.

19. The equipment hanger of claim 13, wherein the body further forms a front inset on the front side of the body configured for inserting a front plate.

20. The equipment hanger of claim 19 further comprising a retaining band configured to hold the back plate in place in the back inset and configured to hold the front plate in place in the front inset.
